(19) United States
(12) Patent Application Publication
(10) Pub. No.: US 2015/0012300 A1
(43) Pub. Date: Jan. 8, 2015

(54) Methods for Establishing a Cloud-based, Interactive Medical Pre-Registration System

(71) Applicant: Virtual Viewbox, L.L.C., San Antonio, TX (US)

(72) Inventor: Douglas K. Smith, San Antonio, TX (US)

(73) Assignee: Virtual Viewbox, L.L.C., San Antonio, TX (US)

(21) Appl. No.: 14/323,428

(22) Filed: Jul. 3, 2014

Related U.S. Application Data
(60) Provisional application No. 61/842,905, filed on Jul. 3, 2013.

(51) Int. Cl. G06F 19/00

(52) U.S. Cl. CPC G06F 19/322; G06F 19/363; G06F 19/3487
USPC 705/3; 705/2

(57) ABSTRACT

The present invention relates to a system of collecting medical information from patients and other sources and distributing information as necessary to medical providers and the devices used by medical providers in the preferred embodiment. The information collected generates triggers of suggested orders and notifications among patients and medical providers. The preferred embodiment of the present invention also relates to an efficient, automated system of generating orders related to patient care.

### BACKGROUND OF THE INVENTION

In the medical field, medical practices and offices have been gradually moving away from the use of paper, analog forms for the collection of patient information when admitting a patient for services. In practice, this non-handwritten form of collection of data related to patient admission serves to provide a more efficient and cost effective level of care, as this theoretically allows for more efficient information sharing. Further, less time is expended on documentation and transcription of records from paper, analog forms into data storage. However, the prior art has not perfected the processes associated with the capture of health information into digital medical records.

In typical practice, when a patient is admitted for service, the patient provides personal health information associated with their healthcare needs. A generally known need is that of sharing patient information among medical practices. would then be entered into a shared system amongst medical providers. This would serve to eliminate any need for redundant completion of forms by the patient as well as time spent by medical staff entering the collected information into a data storage. However, in reality, no universal system exists to efficiently and universally collect, aggregate and transfer patient information among all medical providers.

Although many medical practices have incorporated electronic medical record (EMR) systems into their practices, despite a multitude of efforts to address the problem, information sharing between EMR systems or interoperability between medical practices is almost non-existent. As a result, most patients still must complete analog, paper forms when they visit their doctor and then fill out nearly identical medical forms when referred to an imaging center or another medical provider, sometimes on the same day.

An additional problem arising from the lack of proper information sharing frequently arises when a patient arrives at a radiology center. Upon arrival, the patient once again provides the identical information by completing the medical forms. All too often, the patient undergoes this process only to learn that the examination cannot be performed because the information revealed in this pre-registration or admission process shows that additional laboratory testing, pre-examination preparation, or additional information is required from the ordering doctor before the study can be performed. In this scenario, the patient misses time from work or school, which can equate to lost wages, misdiagnosis, and delays associated with receiving testing at an imaging center or laboratory testing facility.

Furthermore, when a patient is delayed due to lack of needed information, a medical practice or facility such as an imaging center often cannot fill such a time-slot alotted to a patient for examination in an abbreviated window. Thus, the unused time-slot equates to lost revenue for the medical practice or facility and increased costs and wastes associated with the associated inefficiencies. Moreover, a related problem is that no standardized scheduling system exists to enable medical providers and facilities to see the schedule of other medical providers and facilities. Thus, when delays associated with information transfer problems occur, it is difficult for healthcare providers to reschedule appointments among disparate medical entities or groups.

Another major problem persisting with prior art electronic medical record (EMR) systems is that such systems do not communicate with each other efficiently. Furthermore, there exists no pervasive, efficient system to assure effective communication and interactive collaboration with a patient to efficiently collect personal health information from the patent and ensure that any pre-requisite medical actions necessary prior to service are identified, documented and addressed.

Furthermore, an additional problem associated with the field of medical provider documentation is that patient files provided to a second provider from an ordering medical provider are not typically provided to the patient subject of such documentation. Thusly, the patient often cannot review documentation associated with the patient's care prior to receiving care. Also, the patient therefore cannot review related records that would otherwise allow the patient to make an informed decision about ongoing care. For instance, a patient cannot review and contribute to the medical provider's determination of whether pre-requisite testing or procedures are necessary prior to the patient's visit to a second provider. This problem further creates the potential for wasted time-slots and lost time and revenue for both patients and providers.

### SUMMARY

The invention relates generally to the cloud-based exchange of personal health information and scheduling information among a variety of medical providers. The preferred embodiment of the invention allows for automated collection of data from a patient during the pre-registration process associated with an appointment for care with the patient's medical provider. Information collected from a patient or other medical providers (and their systems) is subsequently analyzed and allocated the appropriate medical coding for proper classification and analysis. The analysis of the information provided leads to the questions subsequently being asked of the patient to adapt to the patient's needs and relevant medical providers' needs to collect, organize and assess more useful information.

The preferred embodiment of the invention also enables a patient's medical records received from a first medical provider to be shared and reviewed by the patient before the patient arriving for medical care at the second provider. If the medical records indicate that any additional testing or information is required before the second appointment, these could be addressed prior to the second medical appointment, potentially enabling the associated medical providers to avoid inefficiencies and wastes. The preferred embodiment of the invention enables medical providers in disparate facilities to see each facility's schedule in order to find a time to schedule the appropriate care for the patient. Thus, time and resources are conserved for the patient and all medical providers associated with the patient's care.

Although many medical practices have incorporated electronic medical record (EMR) systems into their practices, information sharing between EMR systems or interoperability between medical practices is almost non-existent. As a result, most patients still complete paper (analogue) forms when they visit their doctor. Patients regularly fill out nearly identical medical forms when referred to an imaging center or another doctor, sometimes on the same day. Frequently a patient arrives at a radiology center and re-completes the medical forms only to learn that the examination cannot be performed because the information revealed in the pre-registration process show that additional laboratory testing, pre-examination preparation, or additional information is required from the ordering doctor before the study can be performed. As a result, the patient misses time from work or school, diagnosis is delayed, and the imaging center wastes the time allotted to the patient for the examination that must now be rescheduled.

It has been left to the present inventor to realize that, generally, it would be much more efficient if the patient's medical records from the first physician could be shared and reviewed by the patient before the patient arriving for medical care at the second provider. If the medical records indicate that any additional testing or information is required before the second appointment, these could be addressed before the second medical appointment saving time and money for the patient and all medical providers including but not limited to, ordering physicians and secondary medical service providers and vendors.

Unfortunately current electronic medical record (EMR) systems do not communicate with each other efficiently and there is no existing methodology for assuring the interoperability required to produce the requisite communication and interactive collaboration with the patient to achieve optimal results. The present invention incorporates solutions to these and related problems in a cloud-based interactive medical pre-registration system.

### BRIEF DESCRIPTION OF THE FIGURES

FIG. 1 Depicts an illustrative diagram of the cloud-based, interactive medical pre-registration system.

FIG. 2. Depicts an illustrative diagram of the cloud-based registration as a service module.

FIG. 3 Depicts an illustrative diagram of the cloud-based, interactive electronic medical ordering system.

FIG. 4 Depicts an illustrative diagram of a medical provider response to the medical questionnaire.

FIG. 5 Depicts an illustrative diagram of a medical provider response to the medical questionnaire to order additional testing.

FIG. 6 Depicts an illustrative diagram of a workflow for responding to a patient based upon a patient's specific needs.

FIG. 7 Depicts an illustrative map of a variety of devices that could interact with or otherwise be utilized by the system.

FIG. 8 Depicts an illustrative flowchart of the compilation and pre-population of a customized questionnaire.

FIG. 9 Depicts an illustrative flowchart of the service request submission from a medical provider.

### DETAILED DESCRIPTION

Cloud computing provides a computer framework for stakeholders to communicate outside the proprietary framework of any single EMR system. A private cloud computing network containing secure authentication and authorization modules can provide a secure, interactive method of data exchange, notification, and electronic ordering and decision making between patients and medical providers that do not share a single electronic medical record system. This private cloud network can be configured to receive the patient's medical information (ePHI) from a variety of sources including patient's electronic personal health method (ePHR), health information exchange (HIE), the EMR systems of the patient's medical providers (hospitals, doctors' offices, laboratories, and diagnostic imaging facilities, amongst others) and thereby providing interoperability between medical providers that do not share the same EMR system. Patients and their doctors can interact quickly when they are both interacting with the same database residing on a web accessible private cloud network. Patients, medical providers, and other stakeholders can utilize a variety of end user such as SmartPhones, laptop computers, and tablet computers to interact with other members of the medical team. Most adults in the US have immediate access to secure internet using ubiquitous mobile devices. Medical technology has evolved rapidly but interoperability between medical practices and the dependent workflows remain slow, inefficient, and expensive.

It has been left to the present inventor to solve the problem associated with the lack of information sharing between referring medical providers or ordering medical providers and receiving secondary providers, medical practices, imaging centers or laboratories via the cloud-computing based system described herein. The following embodiments describing the inventive concepts of the following invention solve the problems associated with a deficiency in information and document sharing between interacting medical service providers.

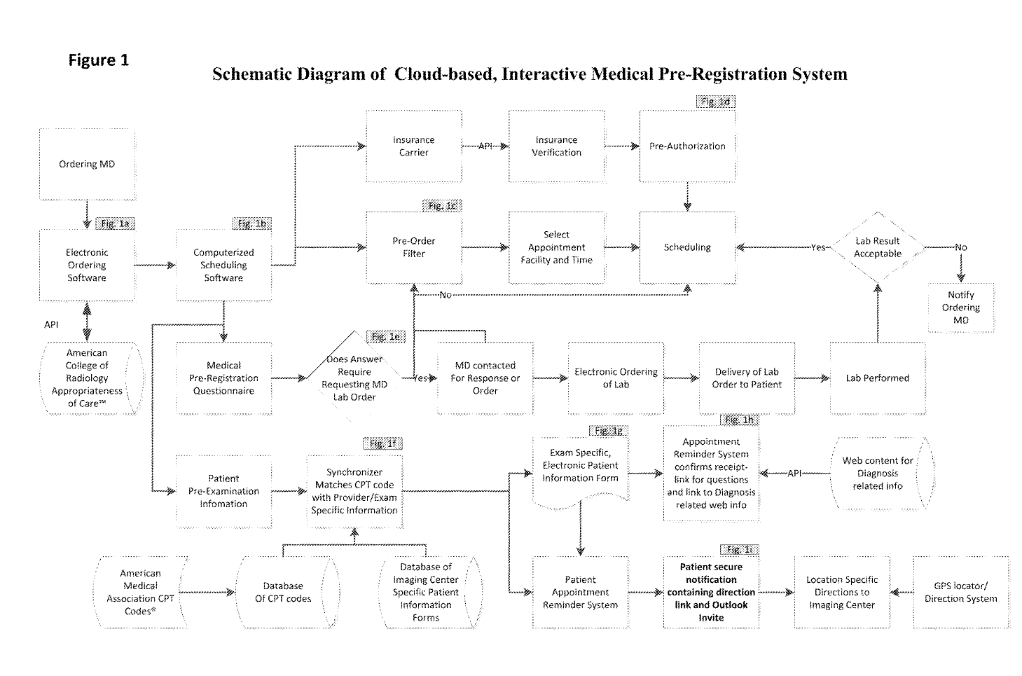

FIG. 1 is a schematic demonstration of one embodiment of hardware and processes of a cloud based, interactive medical pre-registration system. In one embodiment, a physician or medical provider wishes to order a laboratory test, a diagnostic imaging test, or an appointment with another medical service provider. After authenticating using the application's web-based authentication module, the medical provider places an electronic order within the cloud based application electronic ordering software (EOS) (FIG. 1a). The EOS module can receive the electronic order directed from the medical provider's EMR system; by facsimile with importation of ordering data using an analogue to digital conversion module; or the medical provider can complete the interactive form residing within the EOS residing on the private cloud. The electronic ordering software receives information from the American College of Radiology Appropriateness of Care™ site using an application programming interface (API). The EOS module compares the recommendations of the ACRAOC in order to assure that the order requested by the ordering medical provider meets the best practice recommendations of the American College of Radiology. If the submitted medical information does not provide sufficient information to justify the requested study or if the requested test is not the most appropriate study, the EOS notifies the requesting medical provider that additional information is required or that an alternative test is recommended.

Once the OES module has received the electronic order and has confirmed that the ordered test or study is appropriate, the electronic order is transmitted to the computerized scheduling module (FIG. 1b). There are three operational functions of the Computerized Scheduling Module (CSM): 1. Insurance pre-authorization, 2. Select the most appropriate facility and scheduling the appointment; and obtain any health information required by the imaging facility or medical facility from the patient using an interactive health questionnaire. We have described the pre-order filter in a previous application (USPTO Ser. No. 13/354,219 (Filed Jan. 19, 2012)). In brief, the requestor lists his/her preferences for a variety of criteria for the ordered test (e.g. zip code or location of the imaging facility, the highest rated imaging facility based upon the pooled subjective experiences of previous consumers of services at the imaging center; the subjective rating of the available radiologists; the centers that accept the payor's insurance, etc.). The pre-order filter (FIG. 1c) lists the facilities that meet the criteria of the user's preferences and provides an arithmetic measure of the degree of match using a scale of 1-100 with 100 representing a perfect match. The user selects the desired center and the application proceeds with scheduling the procedure at the requested medical or testing facility. The insurance payor pre-authorization module connects to the patient's insurance company's software (using a variety of connectivity technologies including, for example: API, HL7, web portal, amongst other methods). The application extracts the information required by the patient's insurance company to successfully acquire authorization for the requested test or medical treatment (FIG. 1d). The application provides the compiled information to the insurance carrier or payor; obtains the authorization documentation; and provides the authorization number to the selected imaging center or medical facility.

The preferred embodiment of the invention, as illustrated by FIG. 1, comprises a schematic system diagram illustrating one embodiment of secure cloud computing based invention (“Software as a Service”) comprised of a cloud computing device and processes enabling patients to use a variety of user devices to verify medical records and complete medical health information questionnaire. In this embodiment, the questionaire is provided to a patient. The questionnaire is based upon an artificial intelligence guided system, yielding further questions and answers based upon previous answers given by a patient in the questionnaire.

The questionaire is customized specifically for the subject patient to request relevant patient information. The customization of the questionnaire takes place based on a variety of factors. The factors include requirements for information needed for the procedure as indicated by specific imaging center, laboratory or other medical provider facility for which the patient is being pre-registered. The customization of the forms within the questionnaire take into account other factors including the requirements of the relevant payor, such as for instance a commercial insurance provider, Medicare, or workers compensation provider. Payors often have pre-authorization criteria to verify a patient's eligibility for care. The preferred embodiment of the invention incorporates questions stemming from those criteria to help insure that a patient meets pre-requisites for care prior to scheduling the patient for an appointment for the care. Often, providers and payors utilize a specific set of critieria, such as the Milliman Guidelines, the federal or state specific requirements for Workman's Compensation eligibility, or the requirements association with the Colossus system relevant to personal injury cases, to assess the patient's needs and eligibility for care. The answers given by a patient when cross referenced with such criteria yield further relevant questions intended to collect information from the patient relevant to the analysis of whether the patient meets such criteria.

The preferred embodiment of the invention also adapts the questionnaire by incorporating known Clinical Decision Support System (CDSS) tools or functionalities, to address and filter potential medical needs as the patient completes the questionnaire. For instance, the questionnaire may incorporate CDSS tools to ask questions relevant to flu symptoms if a patient indicates that his thermometer reading was 101 degrees.

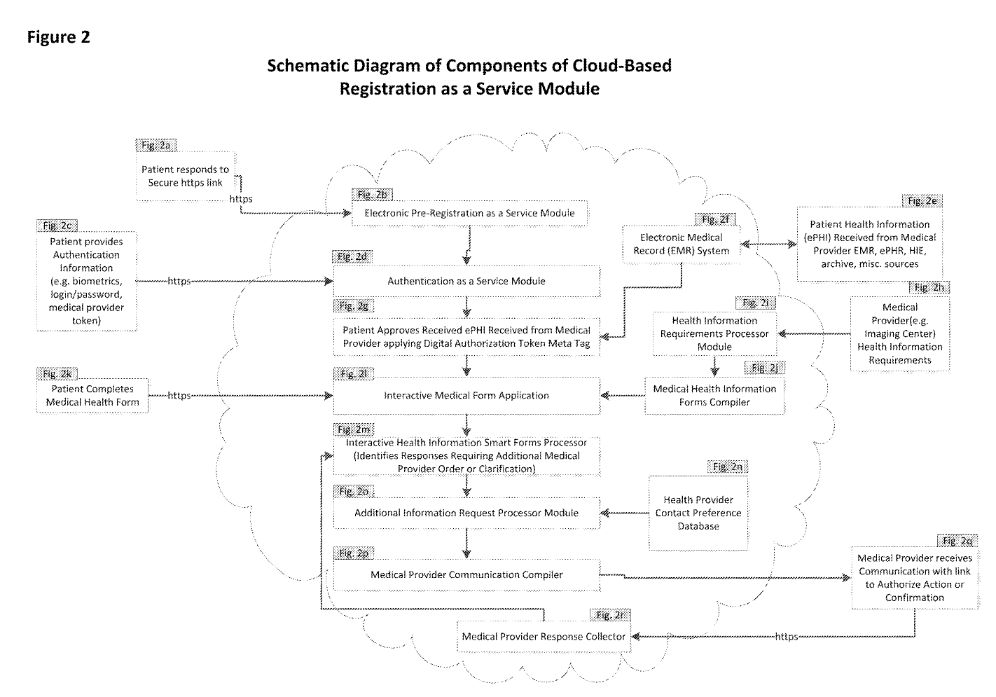

The patient completes the interactive health questionnaire that is maintained on the network. The specific responses of the patient are interactively compared to the requirements and pre-enrollment protocols associated with the specific medical provider, imaging center, payor or other entity relevant to the patient's care. The questionnaire is adjusted to collect information in accord with the requirements of both the specific medical provider offering care for the patient and relevant third parties. Dependent upon the information provided, the responses given may trigger specific actions including but not limited to electronic notifications referring doctor's office request an electronic order of a pre-requisite imaging study, a request for results of a pre-existent report, notification that they study may not be most appropriate test or request for further consultation before the study can be scheduled. The complier associated with the questionnaire translates the diagnoses generated from answers given by patient into the relevant ICD 9/10 code and the procedure required into the appropriate Current Procedure Terminology (CPT) code. Such codes are thereafter utilized in subsequent systems associated with the patient's care. The request is automatically generated from the invention by a processor computer and application that selects the best method of communicating with the ordering physician. This communication can take the form of any known communication protocol including but not limited to SMS, HTML, API, XML or other protocols. In the preferred embodiment, the communication complies with the Health Level 7 (HL7) standard to maximize opportunities for interoperability with other healthcare related systems. In some circumstances, the communication device and processor deliver an electronic order for the pre-requisite laboratory testing to the ordering physician, particularly when responses indicate that a test is a pre-requisite for use. If the referring physician approves the order, the processor and application delivers the electronic order to the patient and the laboratory device and associated laboratory device by means of any communication protocol including but not limited to SMS, HTML, API, XML, etc. In the preferred embodiment, the order notification is delivered to the patient via an SMS message and an e-mail. The notification contains a hyperlink that enables the patient to retrieve documentation relevant to the order. The link in the preferred embodiment connects a patient to a patient portal, which provides access to a “Meaningful Use Compliant Patient Portal System,” as described in U.S. patent application Ser. No. 14/205,361. In the preferred embodiment of the invention, and notifies the administrator and referring physician that the order has been placed. The synchronizer module monitors the order and delivers the pre-requisite laboratory result to the pre-scheduling case manager cue for consideration and action. In the preferred embodiment, the sychronizer furthermore includes a timer module to recognize schedule constraints within which certain actions need to be exeuted within. Further within the preferred embodiment, the synchronizer will escalate those processes to an administrator's attention. The preferred embodiment of the invention incorporates components comprising a cloud based registration device and methods for electronic ordering of medical services (medical treatment and/or medical testing) and comparing with the specific requirements of health care providers petitioned for pre-registration for medical care. The compilation of requirements into the questionnaire incorporates CPT codes, ICD 9/10 codes and payor requirements, which could correspond to Milliman critieria, Colossus system requirements for evaluation of personal injury cases, Worker's Compensation requirements or other requirements. Pre-registration questions are customized to the patient based upon payor type (e.g. commercial payor, Medicare, etc.) and the responses by the patient to questions previously asked of the patient. In the present embodiment, the patient is provided with a notification including a secure link prompting the completion of an electronic pre-registration survey. (FIG. 2) In the preferred embodiment, such notification takes place in the form of an SMS message or an e-mail. Upon clicking on the link, the patient is transferred to an authentication mechanism, which in the preferred embodiment incorporates biometric authentication mechanisms. Other embodiments may incorporate username/password combination or a security token to authenticate the patient. Upon authentication by the patient, the device requests and receives a plurality of data relevant to the patient to display to the patient. Furthermore, within the preferred embodiment, the questionnaire analyzer examines the order and determines appropriateness of the order of the questions, if additional lab tests or documentation are required. The analyzer then customizes the resultant questionnaire per requirements of Clinical Decision Support System (CDSS) tools, payor type, medical provider, patient responses and other criteria relevant to guiding the patient's care.

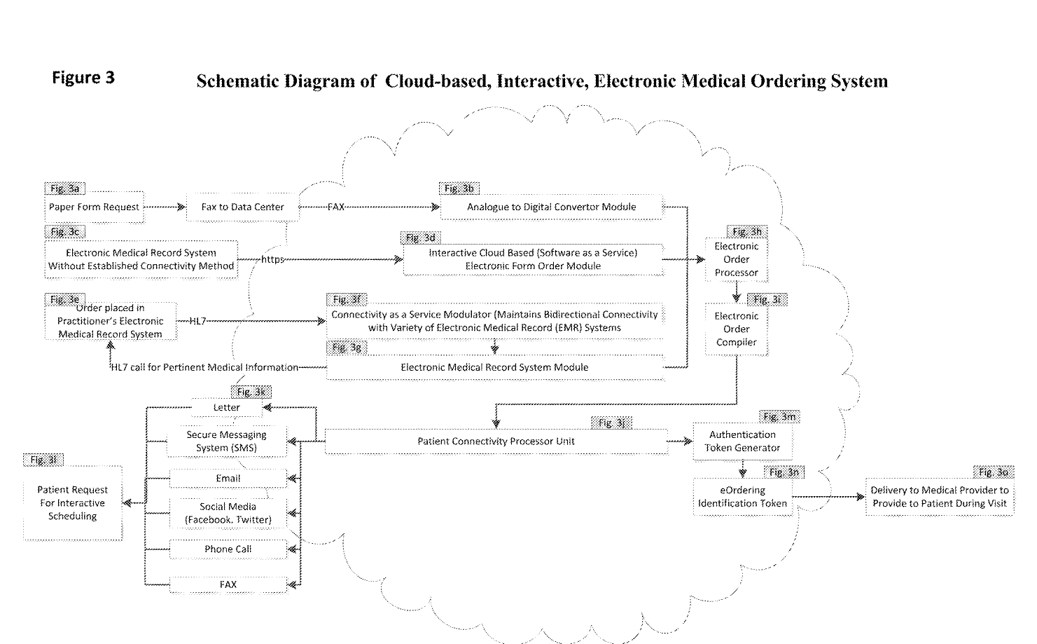

It has been left to the present inventor to solve the problem of a lack of communication between offices due to a lack of connectivity with the preferred embodiment of the invention, a cloud-based, interactive electronic medical ordering system as demonstrated in FIG. 3. FIG. 3 depicts a schematic system diagram illustrating one embodiment of a component of a cloud computing based “Medical Questionnaire as a Service” interactively connected to a processing unit. As shown, the system allows for analog requests to be input into the system by method of faxing the appropriate completed analog form to a data center which converts the information to a digital form for use within the cloud based system. Such conversion may take place via Optical Character Recognition (OCR) or similar technology, or manual data entry by humans. This information is then documented within the electronic medical record system (EMR). The associated devices and methods analyze the patient's responses to the questionnaire and compare to the requirements pre-entered by the medical provider for whom the pre-registration is being performed. Many options exist to communicate with the referring medical provider, including HL7, API, XML file drops or other communication methodologies. In the preferred embodiment, information is deposited into the EMR directly via HL7. Such formatted information is made available to the electronic order processor and following systems. Furthermore, a patient connectivity processor unit communicates with the patient via communication methods including but not limited to a analog mail, email, social media, SMS, telephone and fax. In the preferred embodiment such communications prompt the patient for interactive communication for scheduling purposes. The patient connectivity processor unit also communicates with the medical provider, to generate the proper authentication tokens giving access to a patient's PHI and orders to provide to the patient upon their scheduled visit. Additional information or orders communicated to said provider for prerequisite testing are coordinated by the cloud based invention.

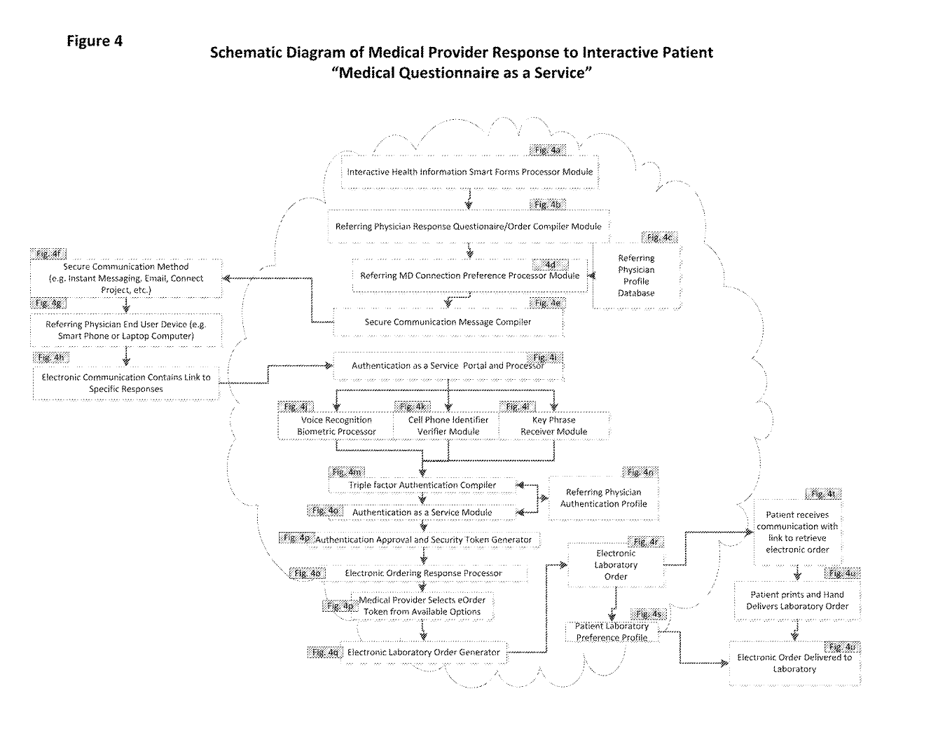

The preferred embodiment of the invention incorporates a secure cloud computing based pre-registration for medical services software as a service component (FIG. 4). Such component allows patients to pre-register for medical services online and coordinate any prerequisite testing or authorization prior to arriving for a medical appointment. In the process of this secure cloud computing, a process of authentication provides information needed for any associated lab tests for only those authorized to receive it. In this case, the patient must provide authorization to receive copies of the lab order from a electronic lab order generator or to have the information directly provided to the lab administering any tests. Such process incorporates the variety of features specifically to enable compliance with the HIPAA Security Rule and the proscriptions of the HITECH Act. In the preferred embodiment, this authorization occurs with a plurality of security measures consisting of a voice recognition biometric processor to confirm that the user providing authentication is in fact the patient, a cell phone identifier to ensure that the call originates from the patient's listed phone number and a key phrase receiver module which prompts and recognizes the secret phrase provided by the patient when initially setting up their account. In varying embodiments individual portions of such security features may be utilized instead of the entirety of all such security mechanisms.

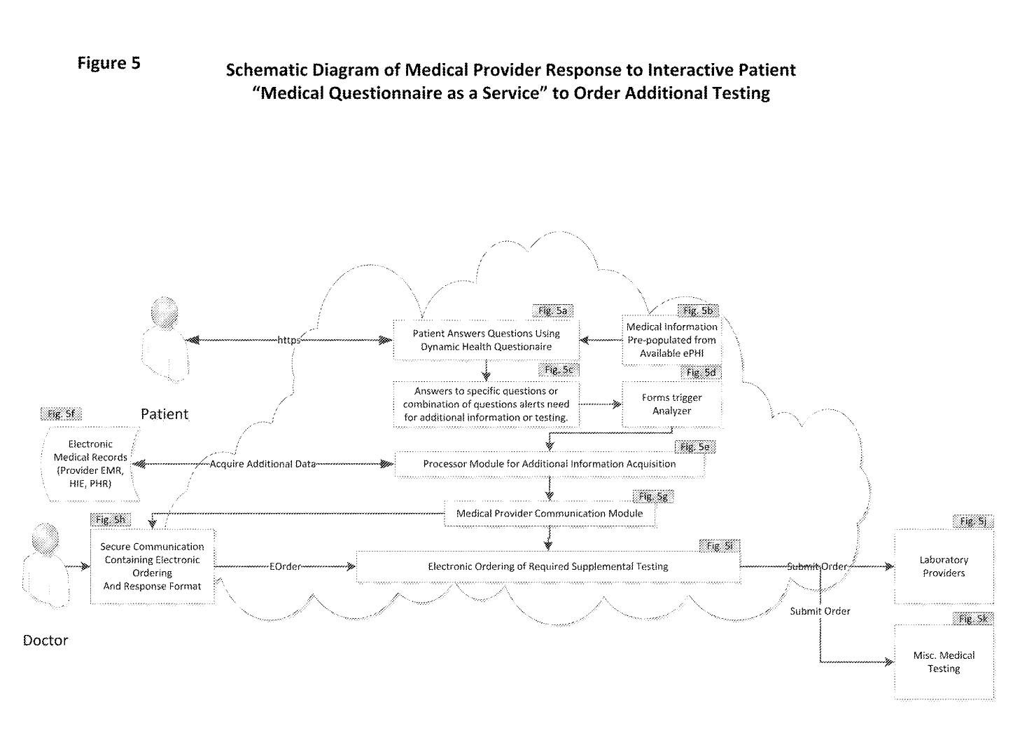

FIG. 5, in general, is a schematic system diagram illustrating one embodiment of secure cloud computing based, interactive “Medical Questionnaire as a Service” demonstrating how a patient's answers on a digital, interactive “smart health” form is tied to the specific requirements of the medical provider for whom the Medical Pre-Registration is being performed. A set of questions generated by the dynamic healthcare questionnaire customized based on a combination of ICD 9/10 code, CPT code, payor requirements, treatment criteria or parts thereof. When a specific combination of ICD 9/10, CPT code, payor requirements indicates that a treatment or test should be ordered on behalf of a patient in accordance with Milliman guidelines, CDSS tools, or other pre-designated criteria, the Forms Trigger Analyzer triggers the appropriate notification to the patient and the medical provider. For instance, the Milliman Guidelines may dictate responses based upon an ICD 9/10 diagnosis code generated from information provided by the patient during the completion of the questionnaire. Such response may include a course of action or order (FIG. 5.c.)

The interactive medical information as a service answers questions given by patients and converts them into suggested into suggested ICD or CPT codes, or cross references them against criteria/guidelines for care, such as the Milliman guidelines. In the preferred embodiment, other known patient information, such as information garnered from an Electronic Medical Records system is pre-populated into the questionnaire. The information compiled into the medical questionnaire as a service, as provided other sources, is utilized to generate requests for additional information, which would aid in the subsequent diagnosis and care of a patient. Such requests are securely transmitted to a medical provider. If a provider chooses to order further testing, prescriptions, or other treatments for the patient, the order is then communicated via a secure communication protocol to laboratories, other medical testing centers, as other service providers relevant to testing.

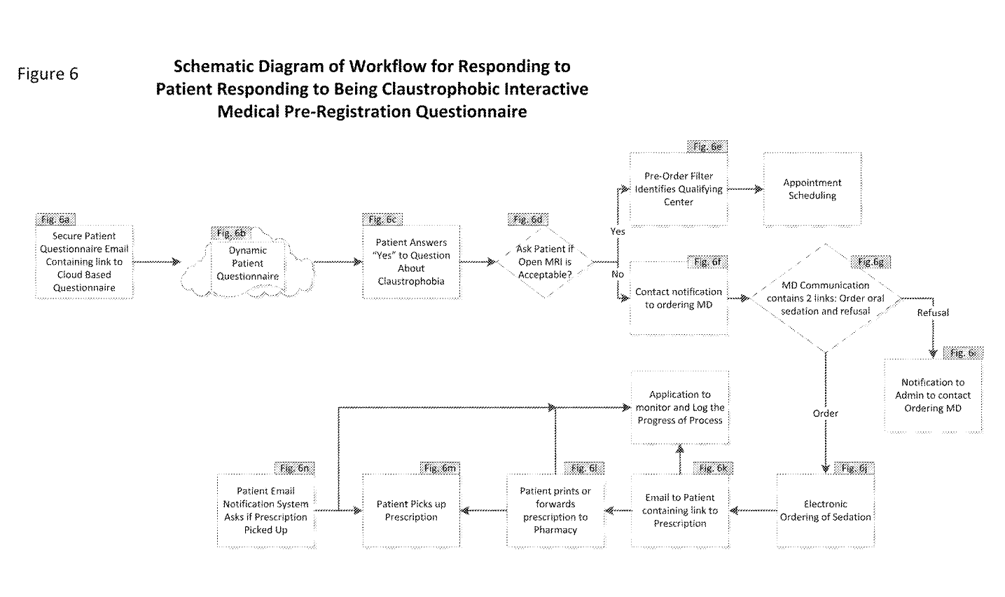

FIG. 6, in general, is a schematic system diagram of an embodiment of the invention illustrating how the system can be utilized to pre-manage a common condition, claustrophobia in this case, that complicates the scheduling of magnetic resonance imaging (MRI), a commonly ordered and performed diagnostic imaging study. In this particular example, the collection of such information relating to a patient condition allows the patient an option of an open MRI facility. Furthermore, if an open MRI facility is not available or is not an acceptable alternative, it provides the ordering MD forward notice to prescribe sedation for the patient.

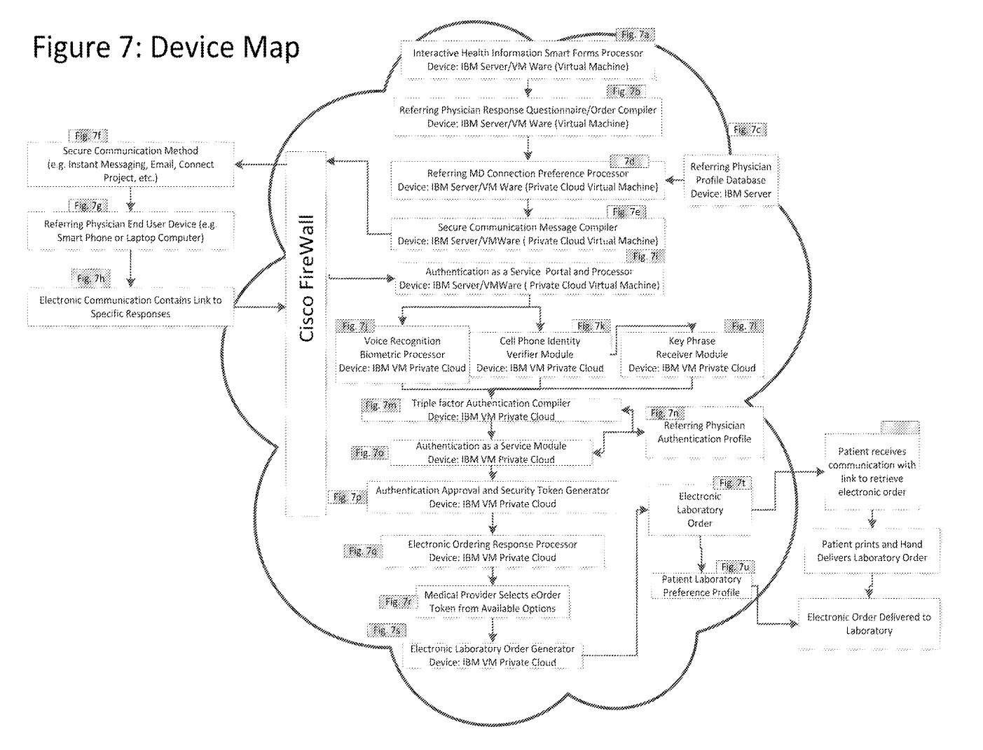

FIG. 7, in general is a schematic device diagram of the private cloud computing architecture supporting the component computer and software modules required to support the various operational components.

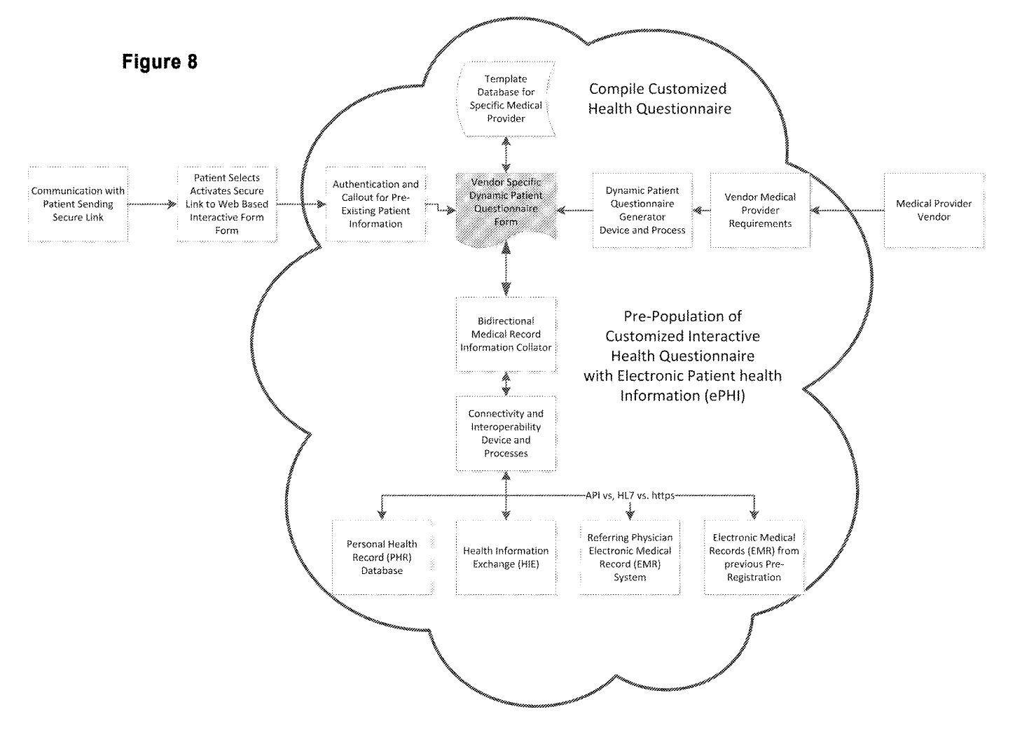

FIG. 8, in general, is a schematic device diagram of a system embodying the inventive principles of the invention illustrating how the system may collect and compile existing patient medical records to pre-populate health questionnaires. The existing medical information is communicated by protocols including API, HL7 and https. More specifically, the questions and information sought to answer said questions are in coordination with third party payor guidelines, Milliman Guidelines, guidelines associated with the Colossus system for personal injury claim evaluation, federal and state Worker's Compensation guidelines and others. Such guidelines in an embodiment of the invention operate in conjunction with criteria given by individual service providers.

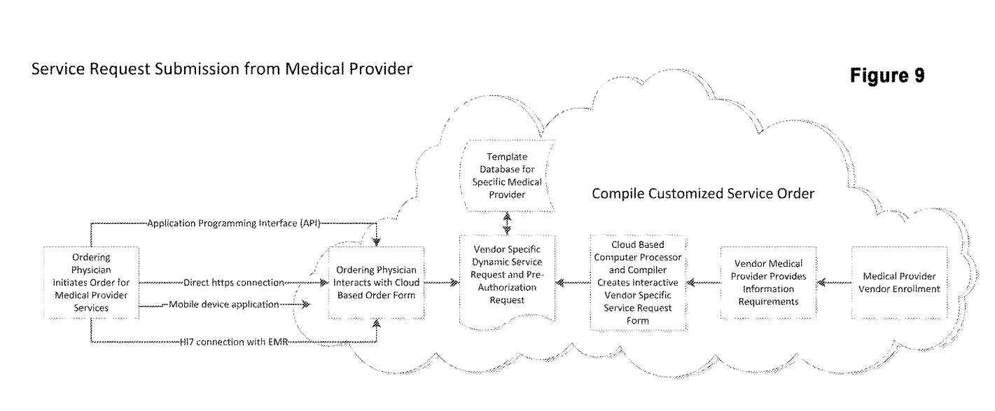

FIG. 9, in general, is a schematic device diagram of a system embodying the inventive principles of the invention illustrating how the system accepts initiating orders from an ordering physician for the use of medical service providers such as an imaging center. The initiating orders may be placed via protocols including but not limited to an API, Direct https connection, mobile device application or HL7 protocols. Based on the initiating orders and associated vendors, the service request prompts the cloud computing system to generate a vendor specific dynamic service request and pre-authorization request in coordination with the criteria of payors.

The Medical Pre-Registration Questionnaire is an interactive health questionnaire with which the patient interacts. The form is pre-populated with electronic medical information obtained from a variety of sources that could include, for example, the patient's electronic Personal Health Record (ePHR); health information exchange (HIE), the EMR system of the patient's medical providers, or information from the patient's previous enrollment in the application. The patient confirms the information populated into the MPRQ and answers the additional questions that are required by the specific imaging center and requested medical test or diagnostic imaging study. The questionnaire is a dynamic form and interactively connected to the application that contains business logic directed by the requirements of the imaging center. The specific answers of the patient trigger actions in the business logic. For example, if the patient is female and being considered for an MRI examination, and if the patient reports that she may be pregnant, the interactive questionnaire adapts diverts the business process into resolving the question of pregnancy that could preclude performance of the requested MRI scan (FIG. 1e). The application notifies the patient's physician and electronically submits an electronic order to the patient's physician to order. The physician electronically submits the order to the appropriate laboratory or submits to the patient to print and submit to the laboratory. If the serum pregnancy test confirms the pregnancy, the application notifies the medical provider that ordered the MRI and suggests that another test may be more appropriate. If the pregnancy test is negative, then the patient is re-engaged into the questionnaire and scheduling process.

The application extracts information for the available patient medical records (ePHI) from a variety of sources and compiles numerical descriptions of the patient clinical history (ICD-10 code) and a numerical description of the most appropriate diagnostic imaging or laboratory testing to evaluate the process (e.g. CPT code.) (FIG. 1f).

A unique Electronic Patient Information Form (ePIF) is created for the exact CPT code/ICD-10 code and specific requirements of the particular imaging center (FIG. 1g). The further questions are determined by the combined payor criteria, along with ICD and CPT suggestions relevant to the patient as further information is collected from a variety of sources, including the patient questionnaire.

The application contains hardware, software and processes that provide diagnosis and exam specific informational content to the patient using a variety of APIs and information sharing connections to content providers. Examples of this content would include specific information about the laboratory or diagnostic imaging testing that is being scheduled, specific information about the patient's diagnosis and the alternative tests or treatments that might be available; reports of scientific studies related to this content; information about the facility that will be providing the services; and patient specific content (e.g. directions to the facility using global positioning system (GPS) locator function in the patient's SmartPhone or tablet) (FIG. 1h).

The application confirms appointment with patient using any of a variety of notification methods (e.g. SMS, email, phone) and uses this contact method to deliver appointment reminders and any patient preparation or information materials to the patient along with an Outlook electronic meeting invitation and directions to the center providing the service using the GPS locator function of the patient's mobile device (FIG. 1i)

The electronic registration as a service process (FIG. 2) initiates with the patient responding to an electronic invitation or link (FIG. 2a) interactively connected to the “electronic pre-registration as a service” (ePRAAS) module (FIG. 2b). In one embodiment, the ePRAAS module consists of a virtual machine (VMware) residing with an IBM server within a secure private cloud network and interactively connected to a multi-tenant collection of virtual machines containing related but separate modules. The patient may connect with the application using a variety of end user devices including for example, SmartPhone, tablet, desktop or laptop computer, medical kiosk.

The patient provides authentication information (e.g. biometric information, login/password, medical provider token) to the “Registration as a Service” module (FIG. 2c) using any of a variety of user devices (e.g. SmartPhone, tablet, desktop or laptop computer, or Kiosk interface) (FIG. 2d). The patient's electronic medical records are obtained from a variety of potential sources including the referring or other physician EMR, the patient's ePHR, HIE, previous medical records within the application archive; imported medical records from CD or other electronic sources, or import of ePHI from another source (FIG. 2e). The ePHI is collated within the application electronic medical record system (FIG. 2f). The patient reviews and verifies his/her ePHI (FIG. 2g) and documents the verification using a digital signature (i.e. application of digital authorization token or meta tag).

The medical service providers (e.g. diagnostic imaging centers, clinical laboratories) (FIG. 2h) provide their informational content to the cloud based Health Information Requirements Processor Module” (FIG. 2i) that collates the ePHI obtained from a variety of service providers. The “Medical Health Information Forms Compiler” creates a unique questionnaire form for the purpose of having the patient provide the specific information required by the specific medical provider in order to pre-screen the patient for the specific imaging procedure, laboratory test, or medical treatment being considered (FIG. 2j). The patient interactively completes the custom form (FIG. 2k) that resides within the “Interactive Medical Form Application” on the secure cloud virtual machine using web based form application (FIG. 2l).

The “Interactive Health Information Smart Forms Processor Module” monitors the responses of the patient to on the interactive form and alters the presentation of the form and triggers modifications of the business logic based upon the responses of the patient. In some cases, a patient response on the custom form may trigger an alteration in operational workflow generated by comparing the requirements of the medical provider that is stored in the Health Provider Content Preference Database” (FIG. 2n). This information is delivered to the “Additional Information Request Processor Module: (FIG. 2o). The “Medical Provider Communication Compiler” (FIG. 2p) compiles requests for additional information to be delivered to medical provider to authorize any request (FIG. 2q). The “Medical Provider Response collector Module” (FIG. 2r) collects the responses from Medical provider(s) and submits the response to the ‘Interactive Health Information Smart Forms Processor”.

The preferred embodiment of the invention incorporates hardware and processes of a cloud based, interactive electronic medical ordering system (FIG. 3). In one embodiment, a physician or medical provider without an electronic medical records (EMR) system wishes to order a laboratory test, a diagnostic imaging test, or an appointment with another medical service provider submits an facsimile order (FIG. 3a). The FAX order is transmitted to the “Analogue to Digital Converter Module” (FIG. 3b) and the contents are extracted by the module and submitted to the EMR system. Alternatively, if the ordering physician has an EMR system but that system does not have a direct, secure electronic connection with the application (FIG. 3c) the ordering physician could interact directly with an ordering form using a secure socket (i.e. ssl connection) in order to submit the electronic order and supporting information. The physician could connect to the application using any of a variety of end user devices including a SmartPhone, tablet, desktop or laptop computer, or Kiosk). The ordering physician interacts with the “Interactive Cloud Based Electronic Form Order Module” (FIG. 3d).

An ordering physician or medical provider placing an order in their EMR (FIG. 3a) may also submit the order using a direct secure connection (e.g. HL7 connection) to a “Connectivity as a Service” module that coordinates the connectivity between the application and the various medical provider electronic medical records systems (FIG. 3f) and coordinates the updating of the EMR system of the application (FIG. 3g).

Once the order is received by a variety of means, the “Electronic Order Processor” confirms the component information and standardizes the format of the information (FIG. 3h). The “Electronic Order Compiler” gathers the component information and compiles a single order that contains the information required by the medical provider that will be providing the services and the medical payor that will be paying for the service (FIG. 3i).

The “Patient Connectivity Processor Unit” determines the options for communicating with each method and determines the optimal communication method for each patient in each clinical context (FIG. 3g). The application may utilize any of a variety of connection methods to communicate with the patient including amongst other: written letter, Secure Messaging System (SMS), email, social media, phone call, or FAX (FIG. 3k). Using any of a variety of connection methods, a request is made to the patient for an interactive scheduling method (FIG. 3l).

Once the order is processed, the order is authenticated and an authentication token is generated (FIG. 3m) and an electronic ordering identification token is created to authorize the electronic order (FIG. 3n). The authenticated electronic order containing a security token is submitted to both the patient and the medical service provider (FIG. 3o).

The preferred embodiment of the invention additionally incorporates a Medical Provider Response to Interactive ‘Medical Questionnaire as a Service’ (FIG. 4). As outlined in FIG. 3, the “Interactive Health Information Smart Forms Processor Module” (FIG. 4a) processes the content required for a health information questionnaire and the “Referring Physician Questionnaire/Order Complier Module” (FIG. 4b) collates the information from the patient pre-registration questionnaire and health information questionnaire and determines if the referring physician needs to be notified or involved in the pre-scheduling process to provide any required additional information or to order any required additional tests (FIG. 4b). Information about the referring physician's preference for method of contact is obtained from the “Referring Physician Profile Database” (FIG. 4c) and the most appropriate method of contacting the ordering physician is determined by the “Referring MD Connection Preference Processor Module” (FIG. 4d) and messaging process is initiated. The “Secure Communication Message Complier” module (FIG. 4e) compiles the physician communication in the form required by the communication methodology. The secure communication is delivered to the physician using the physician's preferred method of communication (FIG. 4f). The referring physician interacts with the communication method using a variety of available end user devices (FIG. 4G) (e.g. SmartPhone, tablet, laptop, or desktop computer, or Kiosk). The secure communication to the referring physician contains a link to the communication on the cloud computer (FIG. 4h). The physician authenticates with the “Authentication as a Service Portal and Processor” (FIG. 4i) using any of a multitude of authentication methods (e.g. voice recognition biometric authentication (FIG. 4j), cell phone identity verifier module (FIG. 4k), key phrase identifier (FIG. 4l), login/password).

The “Triple Factor Authentication Compiler” (FIG. 4m) obtains information from the referring physician's profile that contains the identification information required for authentication (FIG. 4n) and performs authentication using the “Authentication as a Service” Module (FIG. 4o). The “Authentication Approval and Security Token Generator” (FIG. 4p) confirms the referring physician's authentication and generates a security token to verify successful authentication and approves physician access to the electronic ordering response processor (FIG. 4o). The physician approves the electronic order by approving the token from available options of available medical providers (FIG. 4p). The “electronic Laboratory Order generator” (FIG. 4q) generates an electronic laboratory order (FIG. 4r) and the “Patient Laboratory Preference Profile” determines which laboratory is most appropriate for submission of the electronic order (FIG. 4s). The patient receives a copy of the order using one of a variety of electronic communication methods (FIG. 4t). The patient has the option to print the electronic order and submit the order to the laboratory (FIG. 4u). Alternatively the laboratory order may be submitted directly to the laboratory using a variety of communication methods (API, HL7, FAX, SMS, secure email).

The preferred embodiment of the invention also incorporates a “Medical Provider Response to Interactive Patient Medical Questionnaire as a Service to Order Additional Testing” (FIG. 5). The patient interacts with the cloud based “Medical Questionnaire as a Service” using a secure SSL internet connection and answers the questions of the Dynamic Health Questionnaire (FIG. 5a). The patient's ePHI or pre-existing medical information in the system will be pre-populated into the Dynamic Health Questionnaire (FIG. 5c). The patient's responses in the questionnaire (FIG. 5c) are analyzed in the “Forms Trigger Analyzer” (FIG. 5d) to identify responses that trigger alternative supplemental questions (FIG. 5e) or alternative business actions. The additional information may be acquired from any of a variety of ePHI data repositories (e.g. Provider EMR, HIE, PHR, etc.) (FIG. 5f). The “Medical Provider Communication Module” (FIG. 5g) determines the most appropriate method for communicating with the referring physician. A secure communication is submitted to the referring physician (FIG. 5h) using the preferred communication method and contains a link to the electronic order residing in the cloud application (FIG. 5i). The electronic order is provided to the laboratory provider (FIG. 5j) or to miscellaneous medical providers (FIG. 5k).

The preferred embodiment of the invention also incorporates features to respond to a patient response in a variety of contexts. FIG. 6 illustrates this with an example of reporting claustrophobia in the patient health questionnaire. The patient selects the dynamic link (FIG. 6a) that directs the patient to the cloud based “Dynamic Patient Health Questionnaire” (FIG. 6b). The patient answers “yes’ to the question asking whether the patient is claustrophobic (FIG. 6c). The Questionnaire is dynamically altered to ask the patient if an open MRI is an acceptable alternative method of mitigating the patient's claustrophobia (FIG. 6d). If the patient confirms that an Open MRI is acceptable mitigation method (FIG. 6e), the application selects an appropriate Open MRI imaging center and the order is forwarded for scheduling. If the patient answers that an Open MRI is not acceptable, the questionnaire and workflow are altered (FIG. 6f) and communication is initiated to the referring physician is initiated (FIG. 6f). The secure communication to the referring physician includes a electronic ordering link for sedation for the patient. If the physician does not respond or refuses the electronic order (FIG. 6i) the case is referred to program administrator to arrange for alternative solutions. If the referring physician confirms the electronic order for sedation, the electronic order is generated (FIG. 6h). The electronic order is emailed to the patient (FIG. 6k) and the patient prints out the order or submits the electronic order to the pharmacy (FIG. 1). The patient picks up the prescription (FIG. 6m) and the pharmacy notifies the application and the patient is asked to confirm that the prescription has been picked up and that the prescription will be brought with the patient to the MRI appointment.

FIG. 7 is a schematic device map of the system. In general, the preferred embodiment of the invention includes a secure private cloud network comprised of Virtual Machines (VMWare) with both Linux and Windows based operations systems. In one embodiment, the private cloud is protected by a Cisco firewall and secure connectivity using Virtual Private Network (VPN), HL7 connections, and TLC connections.

FIG. 7a demonstrates one embodiment of an “Interactive Health Information Smart Forms Processor Device” which resides on a windows based Virtual Machine. FIG. 7b demonstrates the “Referring Physician Response Questionnaire/Order Compiler” operating on a Windows based Virtual Machine on a IBM Server. The “Referring Physician Profile Database” resides on a Windows SQL database service using Windows operating system (FIG. 7c). The “Referring MD Connection Preference Processor” resides on a Windows based Virtual Machine on an IBM server (FIG. 7d). The “Secure Communication Message Compiler” resides on a Windows based server utilizing Windows operating system (FIG. 7e). The secure communication is generated by the application using a variety of secure communication devices (FIG. 7f). The referring physician utilizes a variety of possible end user devices (FIG. 7g). The communication link directs the referring physician to a specific connection within the secure cloud application (FIG. 7h). The “Authentication as a Service Portal and Processor resides on a Windows based Virtual Machine (FIG. 7i). In one embodiment, the voice recognition processor contains a voice analyzer module and biometric voice analyzer processor residing on a Linux based Virtual Machine on an IBM computer (FIG. 7j). In the continuing embodiment, the “Cell Phone Identity Verifier Module” resides on a Linux based Virtual Machine (FIG. 7k). The “Key phrase Analyzer” module resides on a Linux based Virtual Machine (FIG. 7l). The “Triple Factor Authentication Compiler” resides on a Linx based Virtual Machicne (FIG. 7M). The “Authentication as a System Module” resides on a Windows based Virtual machine (FIG. 7o). The “Authentication and Approval and Security Token Generator” resides on a Windows based Virtual Machine (FIG. 7p). The “Electronic Ordering Response Processor” resides on a Windows based Virtual Machine (FIG. 7q) and the medical provider interacts with the electronic ordering module residing on a Windows based Virtual Machine (FIG. 7r) and the “Electronic Order Generator” resides on a Windows based Virtual Machine (FIG. 7s) and generates the electronic order (FIG. 7t). The “Patient Laboratory Preference Profile’ resides on a Windows based SQL server on a Windows based Virtual Machine (FIG. 7u).

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

Although the present invention has been described in detail, it should be understood that various changes, substitutions, and alterations could be made hereto without departing from the spirit and scope of the invention.

I claim:

1. A system, comprising:
Completing a questionnaire to populate fields with health information;
Synchronizing the health information;
Analyzing the health information;

2. The system of claim 1, further comprising:
Customizing questions in the questionnaire based upon analysis of the health information provided by a patient.

3. The system of claim 1, further comprising:
Customizing questions in the questionnaire based upon the combination of the ICD code, the CPT code and payor information

4. The system of claim 1, further comprising:
Customizing questions in the questionnaire based upon analysis of earlier information provided by a patient within the questionnaire.

5. The system of claim 1, further comprising:
Customizing questions in the questionnaire based upon payor requirements or Milliman criteria.

6. The system of claim 1, further comprising:
Analyzing the health information via the Forms Trigger Analyzer.

7. The system of claim 1, further comprising:
Inputting insurance company pre-authorization requirements;
Customizing questions in the questionnaire based upon the insurance company pre-authorization requirements.

8. The system of claim 1, further comprising:
Determining whether the health information indicates that the referring physician should have involvement in the ongoing care of a patient.

9. The system of claim 1, further comprising:
Generating a potential diagnosis or plurality of potential diagnoses to a patient based upon a patient's responses within the questionnaire;
Allocating an ICD 9 or ICD 10 code to the potential diagnosis or ICD 9 or ICD 10 codes to the potential diagnoses;
Assigning a potential procedure or a plurality of potential procedures to each potential diagnosis or plurality of potential diagnoses;
Allocating a CPT code to the potential procedure or CPT codes to the plurality of potential procedures.

10. The system of claim 1, further comprising:
Comparing a ICD 9/10 code and CPT code combination to payor requirements for authorization for a procedure;
Notifying a patient and a medical provider whether the payor requirements for authorization for a procedure have been met.

11. The system of claim 1, wherein the analyzer further comprises an information smart forms processor.

12. The system of claim 1, further comprising;
Incorporating the information collection needs of alternative medical providers;
Altering the questions asked in the questionnaire according to the needs of the alternative medical providers.

13. A system, comprising:
Authenticating a user;
The user approving or rejecting health information received from a medical provider;
The user completing an interactive medical form application;
Processing information received via the interactive medical form application;
Requesting additional information if necessary;
Compiling health information.

14. The system of claim 13, further comprising:
A medical provider receiving a communication containing a hyperlink to authorize and confirm an action,
Collecting the response of the medical provider;
Assessing whether additional information is needed from the medical provider.

15. The system of claim 13, wherein the authenticating step takes place via a Key Phrase Analyzer.

16. A system, comprising:
Receiving an electronic order from a medical provider;
Compiling the electronic order;
Notifying patient or a different medical provider of the electronic order;
Scheduling an appointment.

17. The system of claim 16, where the scheduling step occurs via scheduling form accessed via a hyperlink.

18. The system of claim 16, where the scheduling step occurs via a scheduling form accessed via a hyperlink contained within a notification delivered to a patient via an e-mail message or a SMS message.

19. The system of claim 16, further comprising:
Formatting an order into a formatted order comprising of HL7 compliant syntax;
Transmitting the order via API or web service;
Delivering the formatted order to a laboratory or medical testing facility.

20. The system of claim 16, further comprising:
Determining whether any required information is missing;
Attempting to incorporate missing information from other sources;
Querying a medical provider to determine whether additional testing is needed.

21. The system of claim 16, further comprising:
Authenticating a medical provider with an Authentication as a Service Portal and Processor.

22. The system of claim 16, wherein the receiving step and notifying step take place via Connectivity as a Service.

23. A system, comprising:
Collecting patient responses via a smart forms processor;
Examining the patient responses;
Identifying a subset of the patient responses that indicate pertinent studies, reports or laboratory testing relevant to the patient.

24. The system of claim 23, further comprising:
Delivering the subset of patient responses that indicate pertinent studies, reports or laboratory testing relevant to the patient to a medical provider via a secured method of communication.

25. The system of claim 23, further comprising
Identifying a subset of the patient responses that require further clarification;
Delivering the subset of patient responses that require further clarification to a medical provider via a secured method of communication.

26. The system of claim 23, further comprising a Medical Health Information Forms Complier.

27. The system of claim 23, further comprising an Interactive Health Information Smart Forms Processor Module.

28. The system of claim 23, further comprising an Additional Information Request Processor Module.
